(19) United States
(12) Patent Application Publication
(10) Pub. No.: US 2003/0001957 A1
(43) Pub. Date: Jan. 2, 2003

(54) Digital camera system and camera recycle system

(76) Inventor: Akihiro Kubota, Kokubunji-shi (JP)

Correspondence Address: STRAUB & POKOTYLO, 1 BETHANY ROAD, SUITE 83, BUILDING 6, HAZLET, NJ, 07730, US

(21) Appl. No.: 10/100,404

(22) Filed: Mar. 18, 2002

(30) Foreign Application Priority Data
Mar. 21, 2001 (JP) 2001-081116

(51) Int. Cl. H04N 5/225

(52) U.S. Cl. 348/207.2

(57) ABSTRACT

There is disclosed a digital camera system in which image information photographed by a digital camera and stored in an image memory is subjected to image processing via a CPU of an image handling apparatus and is taken in the image memory. Content of the image processing is indicated by a user with a user instruction section. Moreover, a fee for operating the system is charged by a charging box. Furthermore, after the fee is paid to the charging box, the CPU performs the processing in accordance with the processing content indicated by the user instruction section. The image information subjected to the processing is output by a printer.

### CROSS-REFERENCE TO RELATED APPLICATIONS

This application is based upon and claims the benefit of priority from the prior Japanese Patent Application No. 2001-081116, filed Mar. 21, 2001, the entire contents of which are incorporated herein by reference.

### BACKGROUND OF THE INVENTION

1. Field of the Invention

The present invention relates to a digital camera system and a recycle system of a camera constituted of an image handling apparatus installed in a service base such as a photography studio and convenience store and a digital camera for photographing a digital image. Moreover, the present invention relates particularly to a system in which a digital camera includes a CMOS image sensor, built-in memory, and minimum necessary capability, and achieves ease of using similarly as a current disposable camera, an image handling apparatus serving both as a digital camera recovering apparatus and a printer is disposed in each base, and therefore a user can easily print out the image.

2. Description of the Related Art

A method for printing an image from an external memory such as smart media brought to a photography studio, or the like by a user, and a method for utilizing a communication circuit to make an order for a print output have been proposed as a digital photo service.

The following system is disclosed, for example, in Jpn. Pat. Appln. KOKAI Publication No. 11-4311. In the system, a transfer request means of a server computer periodically accesses each image handling apparatus, or transmits a request to the apparatus, and a transfer means of each image handling apparatus transfers a digital image in response to each access or request.

Moreover, Jpn. Pat. Appln. KOKAI Publication No. 11-15737 discloses the following system. That is, in the system, for at least one of data recording regions of a recording medium, an access right is set such that the user cannot write data. The access right of at least one another data recording region is set such that the user can write the data. Thereby, a digital input image transferred to a laboratory by the user can be recorded.

Furthermore, Jpn. Pat. Appln. KOKAI Publication No. 11-88577 discloses a photograph processing system in which data from various media can be input, various output forms can be handled, and a client's demand can efficiently be satisfied.

Additionally, Jpn. Pat. Appln. KOKAI Publication No. 11-146308 discloses a system in which instruction information on print processing inputted by the user is efficiently stored in two types of files of an image file and an order file prepared separately from the image file. For the image file, the information is stored in a tag region.

Moreover, in the conventional digital photo service, someone performs clerical work, and a printer specialist also works for print output. Therefore, personnel expenses have been added to a print fee.

Furthermore, time is required similarly as a camera using a 35 mm film, from when image data is brought into the photography studio until the print output is obtained.

Additionally, the digital camera and photo service are not systematized. Additionally, there has not been an idea that the digital camera is inexpensively manufactured on assumption of the photo service.

### BRIEF SUMMARY OF THE INVENTION

Therefore, an object of the present invention is to provide a digital camera system and a recycle system of a camera in which a clerical work and a print specialist are unnecessary for a print output, the print output is obtained in a short time, and a digital camera can inexpensively be manufactured.

A first object of the present invention is to provide a digital camera system which subjects an image photographed by a user with a digital camera to a processing and outputs the image, comprising:

an image information input means for receiving image information photographed by the digital camera;

an image processing means for subjecting the received image information to an image processing;

a user instruction means for allowing the user to indicate a content of the processing applied by the image processing means;

a charging means for charging a fee for operating the system;

a control means for controlling the image processing means to process the image information with the processing content indicated by the user with the user instruction means, after the user has paid the fee to the charging means; and

an output means for outputting the image information processed by the image processing means.

A second object of the present invention is to provide a digital camera system comprising:

an image information input means for receiving image information photographed by a digital camera;

an image processing means for subjecting the received image information to an image processing;

a user instruction means for allowing a user to indicate a content of the processing applied by the image processing means;

a control means for controlling the image processing means to process the image information with the processing content indicated by the user instruction means;

an output means for outputting the image information processed by the image processing means; and

a charging means for charging a user fee from the user,

wherein the control means controls the image processing means to process an image based on the processing content indicated by the user with the user instruction means, when the user pays the fee to the charging means.

A third object of the present invention is to provide a recycle system of a camera, comprising:

a camera insertion means for recovering a digital camera;

an image information input means for receiving image information photographed by the recovered digital camera;

an image processing means for subjecting the received image information to an image processing;

a user instruction means for indicating a content to be processed by the image processing means by a user;

a control means for controlling the image processing means to process the image information with the processing content indicated by the user instruction means;

an output means for outputting the image information processed by the image processing means; and

a charging means for charging a use fee from the user,

wherein the control means controls the image processing means to process an image based on the processing content indicated by the user with the user instruction means, when the user pays the fee to the charging means, and

the digital camera recovered by the camera insertion means is subjected to a memory deletion operation, a battery replacement operation, and a cleaning operation, and is again rented or sold.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a main part in a first embodiment of a digital camera system of the present invention;

FIG. 2 is a flowchart showing an operation of the digital camera system according to the first embodiment;

FIG. 3 is a block diagram showing a constitution of a main part of a recycle system of a camera using a digital camera according to a second embodiment of the present invention;

FIG. 4 is a block diagram showing the constitution of the main part of the digital camera system according to a third embodiment of the present invention;

FIG. 5 is a block diagram showing the constitution of the main part of the digital camera system according to a fourth embodiment of the present invention;

FIG. 6 is a block diagram showing one example of the constitution of the main part of a general digital camera which is applied to the digital camera system of the present invention;

FIG. 7 is a block diagram showing one example of the constitution of the main part of a digital camera exclusive for recording which is applied to the digital camera system of the present invention; and

FIG. 8 is a block diagram showing the constitution of the main part of the digital camera system according to a fifth embodiment of the present invention.

### DETAILED DESCRIPTION OF THE INVENTION

Embodiments of the present invention will be described hereinafter with reference to the drawings.

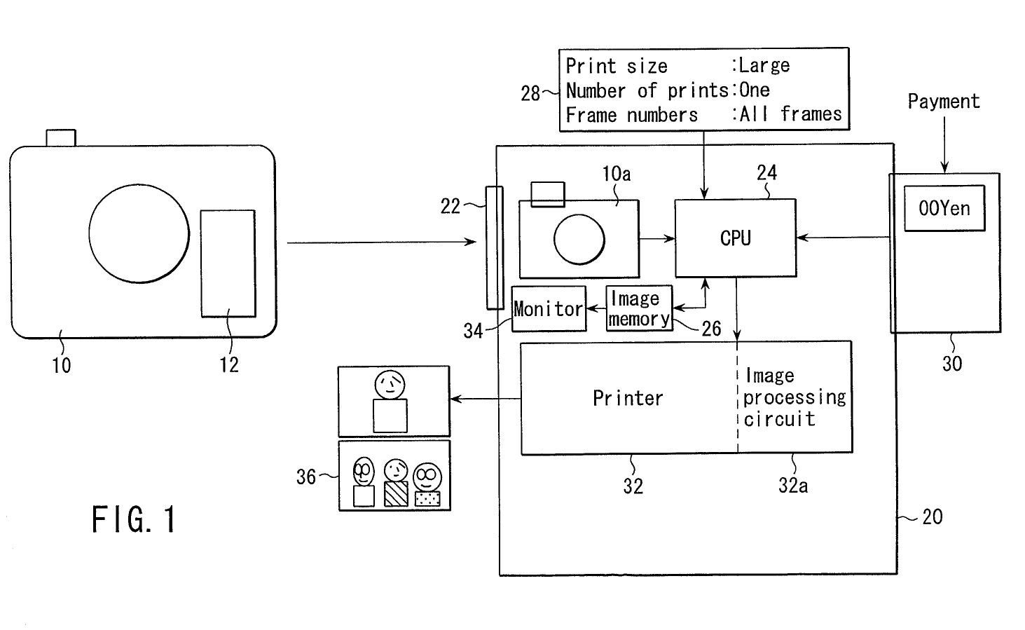

FIG. 1 is a block diagram showing a constitution of a main part in a first embodiment of a digital camera system of the present invention.

In FIG. 1, a digital camera 10 includes an image memory 12. The image memory 12 is attached to the digital camera 10 in such a manner that the memory is not detachable. Moreover, after the digital camera 10 photographs an image, the camera is incorporated into an image handling apparatus 20 described below. Here, the digital camera incorporated in the image handling apparatus 20 is handled as a photographed digital camera 10a.

The image handling apparatus 20 is an apparatus for printing out image data from the photographed digital camera 10a. The image handling apparatus 20 has a camera insertion port 22 through which the photographed digital camera 10a is to be inserted into the apparatus. The image data from the digital camera 10a is supplied to a CPU 24 via a connector (not shown).

The CPU 24 controls the whole image handling apparatus 20. The CPU 24 is connected to an image memory 26, user instruction section 28, charging box 30, and printer 32.

The image memory 26 downloads and stores photographed data of the digital camera 10a. The data incorporated in the image memory 26 is output to a monitor 34, and displayed as a corresponding thumbnail.

Moreover, the user instruction section 28 is a user interface for a user to designate a print size, the number of prints, a frame to be printed for partial print, and the like. The charging box 30 charges a fee in accordance with the printer size, the number of prints, and the like, and has an amount display portion and a payment port.

The printer 32 prints out the image stored in the image memory 26. The printer 32 includes an image processing circuit 32a. Moreover, the image processing circuit 32a in the printer performs JPEG extension, Y conversion suitable for the printer, printer control, and the like. An output image 36 printed out under control of the printer 32 is obtained.

Additionally, the user instruction section 28 is realized by input means such as a keyboard, button, and lever. Moreover, the printer 32 may be for a general purpose, and a printer of an ink jet type, heat transfer type, or the like is used.

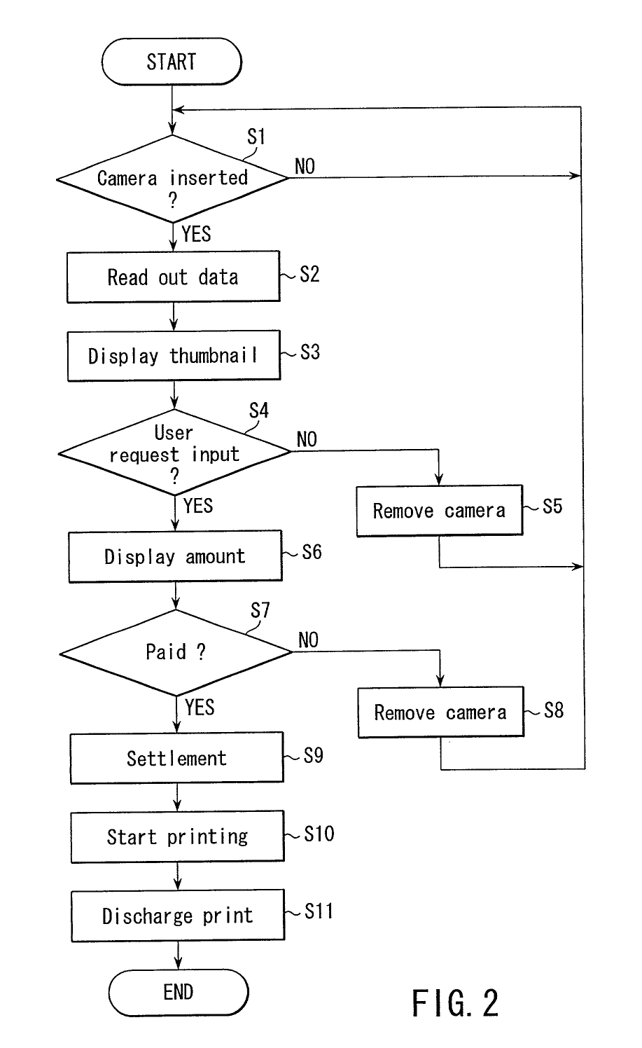

An operation of the digital camera system according to the first embodiment will next be described with reference to a flowchart of FIG. 2.

It is now assumed that the digital camera 10 photographs the image, and the photographed image is stored in the image memory 12. It is first judged in step S1 whether or not the photographed digital camera 10 (digital camera 10a) has been inserted into the image handling apparatus 20 through the camera insertion port 22. Here, when the digital camera 10a is inserted, the flow shifts to step S2.

In step S2, the digital camera 10a inserted through the camera insertion port 22 is brought to a set state in which the camera is connected to a connector (not shown). Moreover, the CPU 24 downloads data such as image data and photography date into the image memory 26 in the image handling apparatus 20 from the image memory 12 attached to the digital camera 10a. In step S3, the image data incorporated in the image memory 26 is displayed as the corresponding thumbnail in the monitor 34.

Here, the user instruction section 28 judges in step S4 whether or not there is an input indicating various requests from the user. The user designates, for example, the print size, the number of prints, and the like. When there is no request input, the flow shifts to step S5. In step S5, the set digital camera 10a is removed from the image hand Thereafter, the flow shifts step S1.

On the other hand, when there is the user request input in step S4, an amount charged in accordance with designated input information is displayed in the display portion of the charging box 30 in step S6. Subsequently, it is judged in step S7 whether or not the user has paid the displayed amount into the box. Here, when the designated amount is not paid, in step S8 the set digital camera 10a is removed from the image handling apparatus 20, and the flow shifts to step S1.

When the designated amount is paid via the charging box 30 in step S7, the charging is settled in step S9. Subsequently, when the settlement is confirmed, in the following step S10, the printer 32 starts printing the image in accordance with the designated information. Thereafter, in step S11, the printed-out output image 36 is discharged from the image handling apparatus 20.

When the photographed digital camera is inserted into the image handling apparatus in this manner, the output image corresponding to the image data is printed out.

Additionally, in the first embodiment shown in FIG. 1, the digital camera is inserted into the image handling apparatus. For example, an interface such as RS232C may be used to connect the apparatus to the digital camera via a cable, or the data may be downloaded from the digital camera via infrared communication.

A second embodiment of the present invention will next be described.

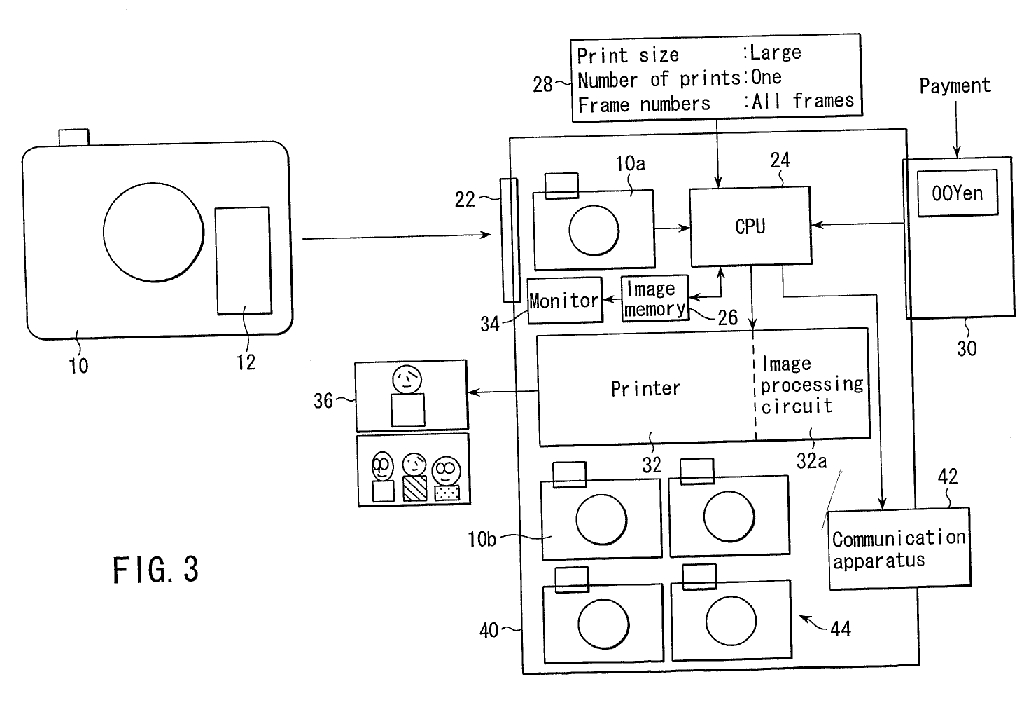

FIG. 3 is a block diagram showing a constitution of a main part of a recycle system of a camera using the digital camera according to the second embodiment of the present invention.

Additionally, in the second embodiment described below, the same constituting elements as those of the first embodiment are denoted with the same reference numerals, and description thereof is omitted.

An image handling apparatus 40 has the camera insertion port 22 through which the photographed digital camera 10 is to be inserted, CPU 24, image memory 26, monitor 34, user instruction section 28, charging box 30, and printer 32, and further includes a communication apparatus 42 and a containing section 44.

The communication apparatus 42 informs the outside of information such as the number of recovered digital cameras. Moreover, the containing section 44 is a section in which the recovered digital camera 10b is temporarily contained.

In the constitution, the photographed digital camera 10 (10a) is inserted into the camera insertion port 22 of the image handling apparatus 40. Then, the CPU 24 downloads the data such as image data and photography date of the digital camera 10 into the image memory 26 in the apparatus 40.

The image downloaded in the image memory 26 is displayed as a thumbnail in the monitor 34. Then, the user refers to the image displayed on the monitor 34, and operates the user instruction section 28, so that the user can designate the information such as the print size and the number of prints.

When the information is designated, the corresponding charged amount is accordingly displayed in the display portion of the charging box 30. Here, when the user pays the displayed amount into the box, the image processing circuit 32a processes the image, and the printer 32 prints the output image 36.

Moreover, the digital camera 10a subjected to the print-out is recovered in the containing section 44 without being returned to the user. The data in the digital camera 10a may be deleted upon or after recovery.

Furthermore, a recovered digital camera 10b recovered in the containing section 44 of the image handling apparatus 40 is periodically recovered by a recoverer. Alternatively, data of the recovered digital camera 10b is one-dimensionally managed, and the digital camera may be recovered by the recoverer as occasion demands using a communication function of the communication apparatus 42.

After the image data in the digital camera is printed out in this manner, the digital camera is recovered, and memory deletion, battery replacement, cleaning, and the like are performed. Therefore, recycling is performed. A serviceman may periodically collect the recovered digital cameras, or may collect the cameras as the occasion demands. In the latter case, the number of digital cameras recovered by each digital camera system is checked through a communication circuit. Since a recyclable component is used in this manner, the cost of the digital camera is advantageously lowered.

Additionally, the following examples of a charging system are considered.

In one example, a first camera is sold at a price from which a profit can be obtained, and an amount obtained by subtracting a rental fee from the price is returned at a time of recovery. In this case, payment may be performed by cash, or a credit card, debit card, prepaid card, and the like may be used.

In another example, the first digital camera is sold at the price from which the profit can be obtained, and a second new digital camera is sold only at the rental fee at the time of recovery.

A third embodiment of the present invention will next be described.

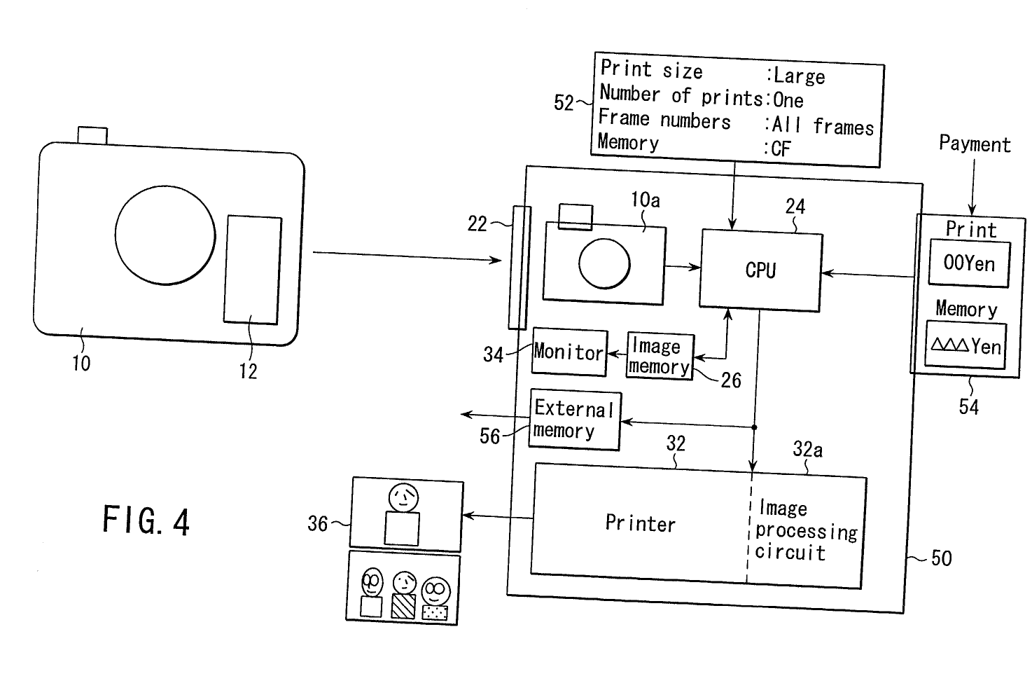

FIG. 4 is a block diagram showing the constitution of the main part of the digital camera system according to the third embodiment of the present invention.

In the third embodiment, an image handling apparatus 50 has the camera insertion port 22 through which the photographed digital camera 10 is to be inserted, CPU 24, image memory 26, monitor 34, user instruction section 52, charging box 54, and printer 32, and further includes an external memory 56 as an external storage medium.

The user instruction section 52 can input not only the information on the print-out, such as the print size and the number of print sheets, but also information on the external memory 56. Furthermore, in the charging box 54, in addition to a print fee, a fee for the external memory 56 is charged.

Moreover, the external memory 56 is a storage medium such as a floppy disk, smart media, and compact flash. In the external memory 56, the image information subjected to the image processing in the image processing circuit 32a of the printer 32 is recorded.

Additionally, as not shown in FIG. 4, the communication apparatus and containing section for the recovered digital camera may be disposed similarly as the constitution of the recycle system of FIG. 3.

In the constitution, the photographed digital camera 10a is inserted into the camera insertion port 22 of the image handling apparatus 50. Then, the CPU 24 downloads the data such as the image data and photography date of the digital camera 10a into the image memory 26 in the apparatus 50. Subsequently, when the thumbnail is displayed in the monitor 34, the user can designate the information such as the print size and the number of sheets through the user instruction section 52.

When the information is designated, the corresponding charged amount including the print fee and the fee of the external memory 56 is displayed in the display portion of the charging box 54. Here, when the user pays the displayed amount into the box, the printer 32 prints the output image 36.

In this case, depending upon selection of the user, when the amount including the fee of the external memory 56 is paid into the charging box 54, the image data to be printed out is stored in the external memory 56 and outputted.

As described above, according to the third embodiment, after the image data in the digital camera is transferred to the user via the external memory, the digital camera is recovered, the memory deletion, battery replacement, cleaning, and the like are performed, and the recycling is thus achieved.

Additionally, the user instruction section 52 is operated in order to select a compression ratio of the image data stored in the external memory 56 and the image data to be stored, so that the user can select a small-capacity storage medium. Therefore, a unit price of the external memory can be saved.

Moreover, the digital camera 10a subjected to the print-out may be recovered without being returned to the user.

A fourth embodiment of the present invention will next be described.

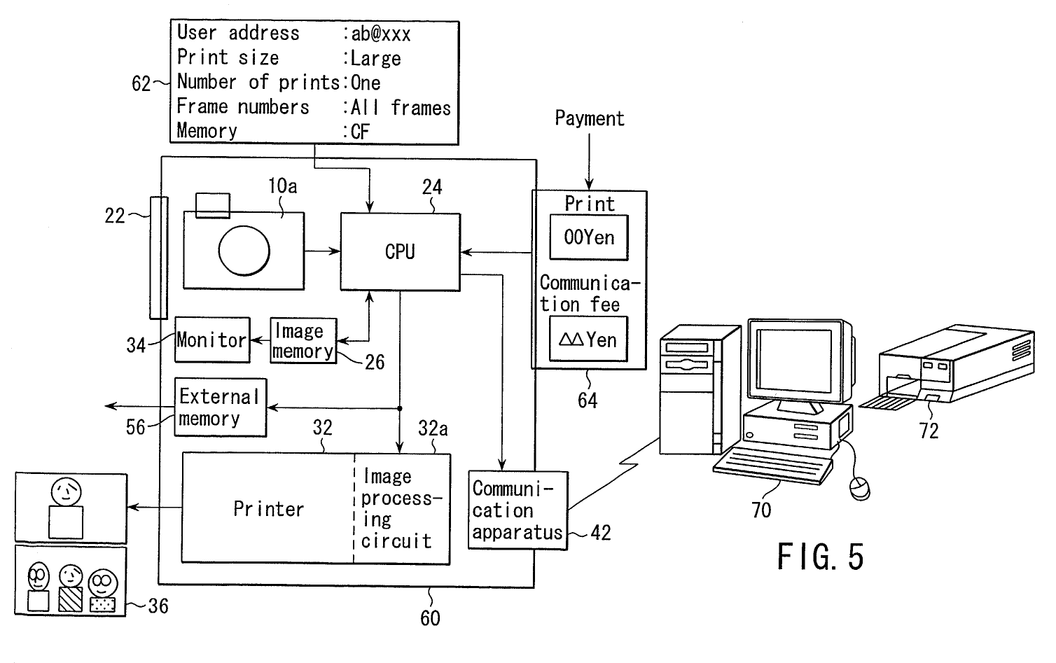

FIG. 5 is a block diagram showing the constitution of the main part of the digital camera system according to the fourth embodiment of the present invention.

In the fourth embodiment, an image handling apparatus 60 has the camera insertion port 22 through which the photographed digital camera 10a is to be inserted, CPU 24, image memory 26, monitor 34, external memory 56, user instruction section 62, charging box 64, printer 32, and communication apparatus 42.

The user instruction section 62 includes a keyboard and monitor. The user instruction section 62 can input the information on the print-out, such as the print size and the number of prints, information on the external memory 56, and an address for transferring the image data to a user's personal computer (PC) 70.

The personal computer 70 is owned by the user, and has a communication function. A user's printer 72 is operated via the personal computer 70.

Moreover, in the charging box 64, in addition to the print fee, a communication fee is charged.

Additionally, as not shown in FIG. 5, the containing section for the recovered digital camera may be disposed similarly as the constitution of the recycle system of FIG. 3.

In the constitution, the photographed digital camera 10a is inserted into the camera insertion port 22 of the image handling apparatus 60. Then, the CPU 24 downloads the data such as the image data and photography date of the digital camera 10a into the image memory 26 in the apparatus 60. Subsequently, when the thumbnail is displayed in the monitor 34, the user can designate the information such as the print size and the number of prints through the user instruction section 62.

In this case, depending upon the user's selection, the image data can be transferred and stored onto storage mediums such as a hard disk drive (HDD) of the user's personal computer 70 (or a designated personal computer) via electronic mail. That is, the user's (or designated) address is input via the user instruction section 62, and communication is performed via the communication apparatus 42, so that the image data is transferred to the user's personal computer 70 (or the designated personal computer).

When the image data is transferred in this manner, the charged amount including the fee determined in accordance with the print size and the number of prints and the communication fee for transferring the data to the personal computer is displayed in the display portion of the charging box 64. Here, when the user pays the displayed amount into the box, the printer 32 prints the output image 36. Additionally, the image data is transferred to the personal computer via the communication apparatus 42.

Moreover, the user may only transfer the image Adata to the user's personal computer 70 without obtaining the output image from the printer 32 of the image handling apparatus 60. In this case, the user can obtain the output image from the image data using the user's printer 72. Additionally, in this case, only the communication fee is charged in the charging box 64.

According to the fourth embodiment, an output means for printing out the photographed image data is given a function of transferring the data via the communication circuit. When the user designates a user's mail address in the output means, the photographed data desired by the user can be transferred. Thereby, the user can take the data into the memory of the user's personal computer without purchasing any external memory, and the cost is advantageously lowered.

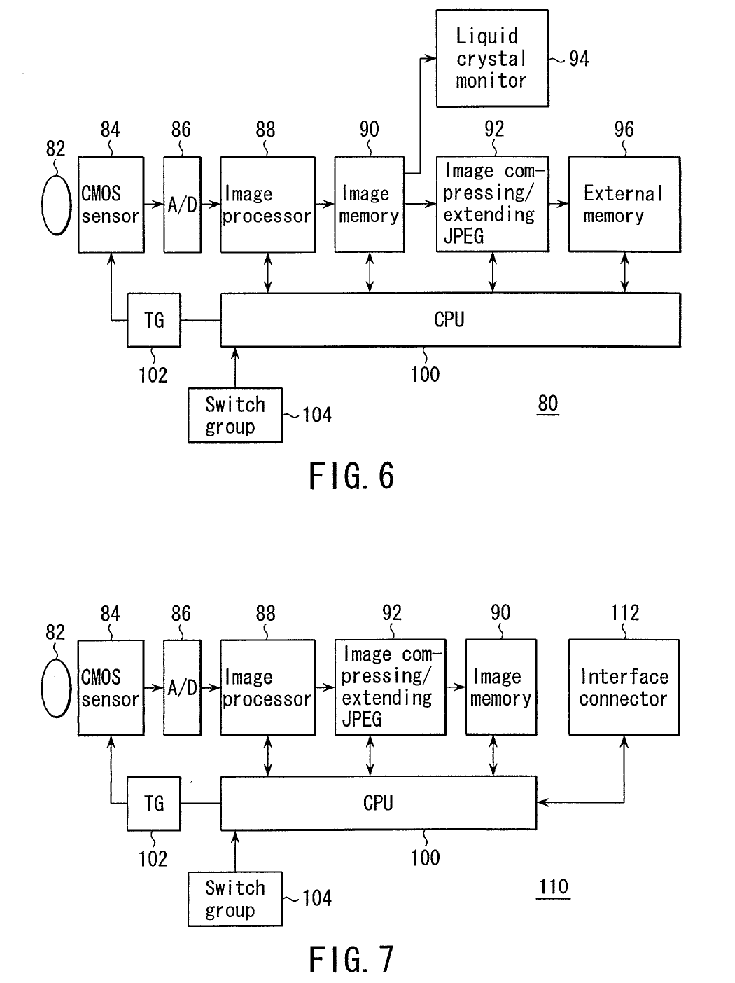

FIG. 6 is a block diagram showing one example of the constitution of the main part of a general digital camera which is applied to the digital camera system of the present invention.

In FIG. 6, a digital camera 80 includes: a lens 82; an image sensor 84 such as an imager; an analog-to-digital (A/D) converter 86 for converting analog data from the image sensor 84 into digital data; an image processor 88 for processing each digital image; an image memory 90; a JPEG processor 92 for compressing/extending the image; a liquid crystal monitor 94 for checking the image to be photographed or the photographed image; an external memory 96 as an attachable/detachable external storage medium; a CPU 100 for performing various controls of the digital camera; a timing generator (TG) 102 for controlling the image sensor 84; and a group of switches 104 including various switches such as a power switch and shutter.

Moreover, in the digital camera 80, a subject image taken via the lens 82 is controlled by the CPU 100 and timing generator 102 and photoelectrically converted by the image sensor 84. Furthermore, the image data converted into an electric signal is taken into the image memory 90 via the analog-to-digital converter 86 and image processor 88. The image taken into the image memory 90 is displayed in the liquid crystal monitor 94. Additionally, after the JPEG processor 92 compresses/extends the image, the image is stored in the external memory 96.

Since the image sensor 84 is constituted of a CMOS sensor in this manner, a low cost and low power consumption can be realized. The power consumption of the CMOS image sensor is generally 1/10 of the consumption of the conventional sensor, and it is therefore possible to miniaturize a battery and the camera.

Furthermore, when the image processing circuit such as a driving circuit and image compression circuit or the image memory is disposed in a chip of the CMOS image sensor 84, further lower cost and lower power consumption can be realized.

In the digital camera system, even when the image memory 90 is defined, for example, for 24 or 36 frames of image, there is no problem. Therefore, a constitution of one chip is realized. Furthermore, in the present digital camera system, when a storage capacity is set, for example, for about 24 frames (similarly as the current disposable camera), the power for use can be saved more than expected. Therefore, the battery can have minimum necessary cost or size, and the camera cost can be saved.

FIG. 7 is a block diagram showing one example of the constitution of the main part of a digital camera exclusive for the recording which is applied to the digital camera system of the present invention.

In FIG. 7, a digital camera 110 includes the lens 82, image sensor 84, analog-to-digital converter 86, image processor 88, JPEG processor 92, image memory 90, CPU 100, timing generator (TG) 102, and group of switches 104, and further includes an interface connector 112.

The interface connector 112 is a connector required for outputting the image data taken into the image memory 90 to the outside of the digital camera 110, because the digital camera 110 does not have any external memory. Therefore, in order to constitute the camera which is exclusive for the recovery, the special interface connector 112 is used. On the other hand, when a general-purpose interface connector is used, a special image format is used.

For the digital camera 110, to constitute the digital camera exclusive for the recording, the liquid crystal monitor 94 and external memory 96 are omitted from the digital camera 80 shown in FIG. 6. That is, the digital camera 110 has substantially the same capability as that of the current 35 mm film camera, so that the cost is reduced. Since the digital camera is recycled, the camera can inexpensively be set.

FIG. 7 shows the CMOS sensor as the image sensor. When an artificial retina LSI is used in the image sensor, a peripheral function can be integrated, and a low voltage and low power consumption can be achieved. For example, in M64270P (trade name) manufactured by Mitsubishi Electric Corp., in addition to the image sensor, image processing functions such as color correction, γ conversion, black level correction, and noise reduction, an eight-bit analog-to-digital converter, and a control circuit are built in one chip. Therefore, the digital camera can be realized by a microcomputer and memory.

Furthermore, it is also possible to use a monochromatic image sensor in the image sensor. In the monochromatic image sensor, with the same pixel number, a resolution is tripled at maximum as compared with a color image sensor. Moreover, with the same resolution as that of the color image sensor, the pixel number can be reduced, and the cost can be lowered. The image processing is also simplified as compared with a color image processing, and a circuit cost can therefore be reduced.

According to the digital camera 110, the camera function is limited to a recording function. Concretely, the liquid crystal monitor for preview or reproduction display, external memory terminal, and the like are omitted. This can produce an effect that the camera is recycled and the digital camera is inexpensively manufactured. Moreover, a connection terminal may be disposed so that an external monitor of a cellular phone, PDA, or the like can be utilized.

A fifth embodiment of the present invention will next be described.

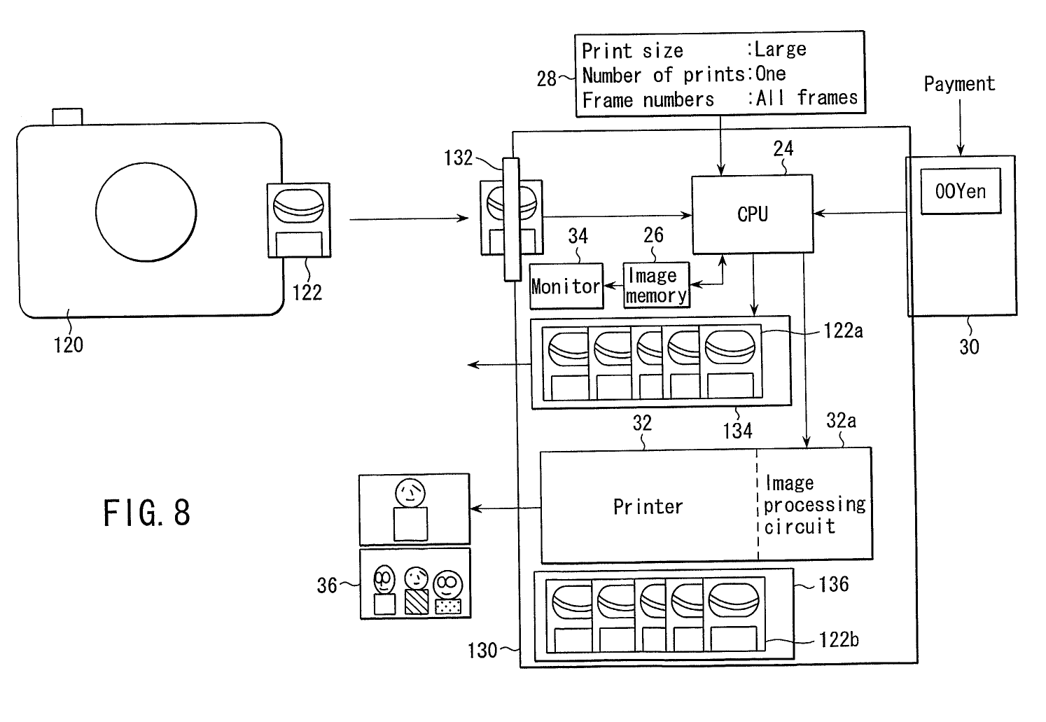

FIG. 8 is a block diagram showing the constitution of the main part of the digital camera system according to the fifth embodiment of the present invention.

In FIG. 8, an attachable/detachable external storage medium 122 such as smart media is attached to a digital camera 120. It is recorded in the external storage medium 122 that the camera has been purchased via an image handling apparatus 130.

Moreover, the image handling apparatus 130 is an apparatus for printing out the output image corresponding to the image data from the external storage medium 122 detached from the digital camera 120.

The image handling apparatus 130 has a memory insertion port 132 through which the photographed external storage medium 122 is to be inserted into the apparatus. The image data from the external storage medium 122 inserted through the memory insertion port 132 is supplied to the CPU 24 via the connector (not shown).

The CPU 24 controls the whole image handling apparatus 130. The CPU 24 is connected to the image memory 26 for downloading and storing the photographed data recorded in the external storage medium 122, monitor 34, user instruction section 28, charging box 30, and printer 32.

The image processing circuit 32a in the printer 32 performs JPEG extension, γ conversion suitable for the printer, printer control, and the like. Under the control of the image processing circuit 32a, the printed-out output image 36 is obtained from the printer 32.

Furthermore, the image handling apparatus 130 includes a containing section 134 for containing an external storage medium 122a for sale (for rent), and a containing section 136 for containing a recovered external storage medium 122b.

That is, the user purchases the external storage medium 122a for sale with the image handling apparatus 130. After the image is photographed with the digital camera 120, the photographed external storage medium 122 is inserted into the image handling apparatus 130, and the image can thereby be printed out.

Moreover, through the user's selection, the photographed external storage medium 122 may be recovered, or transferred back to the user after the data is deleted. In case of the recovery, it is judged whether the medium was purchased via the image handling apparatus 130. With the external storage medium purchased via the image handling apparatus 130, a part (e.g., several percent) of the amount is paid back to the user.

Furthermore, the recovered external storage medium 122b is temporarily recovered in the containing section 136.

At a time of the recovery, it is judged as described above whether or not the external storage medium was purchased by the present digital camera system. When the medium is purchased by the system, several percent of the sales price of the storage medium may be paid back to a purchaser.

Additionally, according to the digital camera system, the digital camera system is disposed in bases such as a photography studio and convenience store, and the fee is charged in accordance with the number of print sheets, size, and the like by the charging box as charging means like a copying machine disposed in the convenience store. Therefore, since the user performs the printing by himself, a clerical work and print specialist are unnecessary. Moreover, only several minutes are required for obtaining the print output, and the time can advantageously be shortened.

Furthermore, when the number of photographs of the digital camera is small, the compression ratio of the image is high, and data amount is small, the data is outputted to the external memory constituted of a floppy disk having a low unit price. On the other hand, when the data amount is large, the data is recorded in memories such as smart media and compact flash. Either method can be selected by the user. Alternatively, the image data to be recorded in the external memory may be selected with reference to the printed-out image.

Furthermore, when an artificial retina chip is used in the CMOS image sensor of the digital camera, the sensor can be manufactured at a low cost, and the digital camera can be inexpensively manufactured.

Alternatively, when a monochromatic chip is used in the image sensor of the digital camera, the low cost, or the high resolution can be achieved.

Additionally, according to the recycle system of the camera, since the external storage medium of the digital camera is rented, the user does not have to purchase the expensive external storage medium.

As described above, according to the present invention, there can be provided the digital camera system and the recycle system of the camera in which the clerical work and print specialist are unnecessary at a time of print output, only a short time is required to obtain the print output, and the digital camera can be inexpensively manufactured.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A digital camera system which subjects an image photographed by a user with a digital camera to a processing and outputs the image, comprising:
an image information input means for receiving image information photographed by the digital camera;
an image processing means for subjecting said received image information to an image processing;
a user instruction means for allowing the user to indicate a content of the processing applied by said image processing means;
a charging means for charging a fee for operating the system;
a control means for controlling said image processing means to process the image information with the processing content indicated by the user with said user instruction means, after the user has paid the fee to said charging means; and
an output means for outputting the image information processed by said image processing means.

2. A digital camera system according to claim 1, wherein said output means outputs a recording sheet on which image information processed by said image processing means is printed, or outputs and stores said image information into an external memory connected to the digital camera system.

3. A digital camera system according to claim 1, wherein said output means has a communication circuit for transmitting the image information processed by said image processing means to the user.

4. A digital camera system according to claim 1, wherein said digital camera uses a CMOS image sensor as photography means.

5. A digital camera system according to claim 4, wherein at least one electric circuit in said image processing means is constituted integrally with said CMOS image sensor.

6. A digital camera system according to claim 2, wherein said charging means determines an amount to be charged in accordance with a printer size and the number of print sheets indicated by the user with said user instruction means, or a type of said external memory.

7. A digital camera system according to claim 2, wherein said image processing means performs a compression processing of said image information in accordance with a compression ratio of the image indicated by the user with said user instruction means and a type of said external memory, and
said output means outputs and stores the image information subjected to said compression processing to said external memory.

8. A digital camera system according to claim 4, wherein said CMOS image sensor uses an artificial retina chip.

9. A digital camera system according to claim 1, wherein said digital camera uses a monochromatic image sensor as photography means.

10. A recycle system of a camera using the digital camera system according to claim 1, comprising:
a camera insertion means for recovering a digital camera,
wherein said image information input means receives image information photographed by the digital camera inserted into said camera insertion means, and the recovered digital camera is subjected to a memory deletion operation, a battery replacement operation, and a cleaning operation, and is again rented or sold.

11. A recycle system of a camera according to claim 10, wherein said digital camera is connected to the recycle system and a reproduction instruction of the image is given by said user instruction means in order to confirm a content of an image photographed by said digital camera so that the image photographed by said digital camera can be confirmed by display means of the recycle system.

12. A recycle system of an external storage medium connectable to a camera using the digital camera system according to claim 1, comprising:
a memory insertion means for recovering said external storage medium,
wherein said image information input means receives image information stored by said external storage medium inserted into said memory insertion means, and the recovered external storage medium is subjected to a memory deletion operation, and a cleaning operation, and is again rented or sold.

13. A digital camera system comprising:
an image information input means for receiving image information photographed by a digital camera;
an image processing means for subjecting said received image information to an image processing;
a user instruction means for allowing a user to indicate a content of the processing applied by said image processing means;
a control means for controlling said image processing means to process the image information with the processing content indicated by said user instruction means;
an output means for outputting the image information processed by said image processing means; and
a charging means for charging a use fee from said user,
wherein said control means controls said image processing means to process an image based on the processing content indicated by the user with said user instruction means, when said user pays the fee to said charging means.

14. A digital camera system according to claim 13, wherein said output means outputs a recording sheet on which image information processed by said image processing means is printed, or outputs and stores said image information into an external memory connected to the digital camera system.

15. A digital camera system according to claim 13, wherein said output means has a communication circuit for transmitting the image information processed by said image processing means to the user.

16. A digital camera system according to claim 13, wherein said digital camera uses a CMOS image sensor as photography means.

17. A digital camera system according to claim 16, wherein at least one electric circuit in said image processing means is constituted integrally with said CMOS image sensor.

18. A digital camera system according to claim 14, wherein said charging means determines an amount to be charged in accordance with a printer size and the number of print sheets indicated by the user with said user instruction means, or a type of said external memory.

19. A digital camera system according to claim 14, wherein said image processing means performs a compression processing of said image information in accordance with a compression ratio of the image indicated by the user with said user instruction means and a type of said external memory, and
said output means outputs and stores the image information subjected to said compression processing to said external memory.

20. A digital camera system according to claim 16, wherein said CMOS image sensor uses an artificial retina chip.

21. A digital camera system according to claim 13, wherein said digital camera uses a monochromatic image sensor as photography means.

22. A recycle system of a camera, comprising:
a camera insertion means for recovering a digital camera;
an image information input means for receiving image information photographed by said recovered digital camera;
an image processing means for subjecting said received image information to an image processing;
a user instruction means for indicating a content to be processed by said image processing means by a user;
a control means for controlling said image processing means to process the image information with the processing content indicated by said user instruction means;
an output means for outputting the image information processed by said image processing means; and
a charging means for charging a use fee from said user,
wherein said control means controls said image processing means to process an image based on the processing content indicated by the user with said user instruction means, when said user pays the fee to said charging means, and
the digital camera recovered by said camera insertion means is subjected to a memory deletion operation, a battery replacement operation, and a cleaning operation, and is again rented or sold.

23. A recycle system of a camera according to claim 22, further comprising:
a display means for displaying the image information received by said image information input means,
wherein said digital camera is connected to the recycle system and a reproduction instruction of the image is given by said user instruction means in order to confirm a content of an image photographed by said digital camera so that the image photographed by said digital camera can be confirmed by said display means.
